(19) United States
(12) Patent Application Publication
(10) Pub. No.: US 2010/0072302 A1
(43) Pub. Date: Mar. 25, 2010

(54) Discharge device

(76) Inventor: Miro Cater, Daytona Beach, FL (US)

Correspondence Address: FLYNN THIEL BOUTELL & TANIS, P.C., 2026 RAMBLING ROAD, KALAMAZOO, MI, 49008-1631, US

(21) Appl. No.: 12/284,244

(22) Filed: Sep. 19, 2008

(51) Int. Cl. A62C 11/00

(52) U.S. Cl. 239/333

(57) ABSTRACT

The invention relates to a discharge device for a liquid pharmaceutical medium having a reservoir for storing the medium, a pressurizing device (10) for feeding the medium and at least one discharge opening (80) for delivering the medium to an environment, the pressurizing device (10) having a pressure chamber (16), whose content can be pressurized by a translationally movable piston (14).

According to the invention there is a piezoactuator device with a piezoactuator operatively coupled to the piston, or a coil actuator device (30) with an actuator coil (30) and an actuator core (32) to which force can be applied relative to actuator coil (30) by energizing the latter and either actuator coil (30) or actuator core (32) is fixed relative to the piston.

Use for producing precisely defined fluid pressures in a discharge device.

### FIELD OF APPLICATION AND PRIOR ART

The invention relates to a discharge device for a liquid pharmaceutical medium having a reservoir for storing the medium, a pressurizing device for feeding the medium and at least one discharge opening for delivering the medium to an environment, the pressurizing device having a pressure chamber, whose content can be pressurized by means of a translationally movable piston.

Numerous different such discharge devices are known from the prior art and are used for the delivery of pharmaceutical media which, in the sense of the invention, is understood to mean substances which are applied to or into the body of a patient for medical purposes. As a function of the discharge device discharge can take place in the form of droplets, a jet, a mist or the like.

In such discharge devices the reservoir is used for storing the medium prior to the discharge thereof. For discharging the medium part of the medium previously delivered to the pressure chamber from the reservoir is pressurized in order to feed it to the discharge opening.

The actuation of the pressurizing device preferably constructed as a pumping device in most discharge devices known from the prior art takes place manually, i.e. by a pressurization during which the necessary energy is introduced by the user into the system. This leads to numerous disadvantages, including for elderly people difficult operation and also the possibility of incorrect manipulation.

### Problem and Solution

Thus, the problem of the invention is to so further develop such a discharge device that the prior art disadvantages are reduced or avoided.

According to the invention this is achieved by such a discharge device which has a piezoactuator device or coil actuator device, the piezoactuator device having a piezoactuator which is operatively coupled to the piston, or where the coil actuator device has an actuator coil and a actuator core, to which force can be applied via the actuator coil by energizing the latter and either the actuator coil or actuator core is constructed in fixed manner with respect to the piston.

In the sense of the invention piston is understood to mean a section movable in translational manner with respect to the casing of the discharge device and whose position determines the pressure chamber volume. A piston in the sense of the invention can also be the movable front side of a pump bellows of a bellows pump.

In the embodiment with a piezoactuator device, the piezoactuator changes its extension in at least one dimension by energization and is supported with one side on a surface fixed with respect to a casing of the discharge device, whereas the opposite side is movable due to the length extension of the piezoactuator and is so directly or indirectly connected to the piston that the movable of said opposite side brings about a movement of the piston. The piezoactuator is preferably constructed as a piezo-stack in order to bring about a comparatively significant displacement of the movable side. As a result of the high forces attainable and the accurate dosability of the forces, piezoactuators are particularly suitable for force application to the piston and make it possible to produce a clearly defined pressure in the pressure chamber.

It is particularly advantageous if the piezoactuator device is operatively coupled to the piston by means of a converter, the latter being constructed in order to displace the piston as a result of the deformation of the piezoactuator by a path length L1 by a path length L2 which is greater than the path length L1. Thus, the converter is constructed for lengthening the comparatively limited deformation path of the piezoactuator, accompanied by a corresponding reduction of the forces. This makes it possible to obtain a significant piston stroke. The converter can be constructed as a mechanically acting gear, which e.g. brings about a conversion by means of a fixed mounted lever. It is also possible to use a hydraulic converter such that as a result of the piezoactuator an auxiliary piston with a large piston surface is directly moved and which displaces an auxiliary fluid, which in turn is used for moving a second auxiliary piston with a comparatively small piston surface. The main piston, which defines the pressure chamber, can be directly linked with said second auxiliary piston.

In the case of the design with a coil actuator device use is made of the fact that an energized coil forms a magnetic field in which a force is applied to the actuator core as a result of magnetic forces. To increase this effect the actuator core is preferably constructed as a permanent magnet. The force acting on the actuator core is dependent on the intensity of the current flowing in the actuator coil.

The described force can be directly used for displacing the piston or supplying a force thereto. For this purpose it is possible to provide the actuator coil in fixed manner with respect to the pump casing and for the actuator core to be fixed relative to the piston. Any movement and force application to the actuator core leads to a corresponding movement or force application to the piston. This construction is particularly simple, because a power supply only has to be provided for fixed components.

However, it is alternatively possible for the actuator core to be fixed relative to the pump casing and to provide the actuator coil on the piston. This second design, which with respect to its construction roughly corresponds to a loudspeaker, offers the advantage that the comparatively lightweight actuator coil is moved relative to the actuator core, so that the energy requirements are lower.

In a further development of the invention a measuring device is provided making it possible to detect the deflection of the piston relative to a pump casing.

In the simplest case the measuring device can be so constructed that it merely detects whether there has been a piston movement. However, it can also be constructed so as to precisely detect the piston position. The measuring device inter alia makes it possible to check prior to putting into operation or operation, whether the piston has moved as a reaction to the energization of the piezoactuator or actuator coil. With more complex designs the measuring device is also able to detect which further forces, such as e.g. frictional forces or spring forces act on the piston. Such an analysis of the characteristics of the specific discharge device makes it possible in operation to produce a precisely defined pressure in the pressure chamber, which offers numerous advantages as a function of the intended use.

A discharge device in which the measuring device has a measuring coil constructed for determining the position of a measuring core relative to the measuring coil is particularly advantageous. Use is made of the fact that a movement of the permanent magnetic measuring coil leads to the induction of a voltage in the coil. The higher the speed of the measuring core relative to the measuring coil the higher said voltage. It is consequently possible to detect as a result of this whether the measuring core is moving and also how fast it is moving. The mere detection of the fact that the core is moving makes it possible to determine the frictional forces acting between piston and pump cylinder, in that the piston is moved between a first and a second end position and the movement time is detected and this increases with the magnitude of the frictional forces.

The pressure produced in the pressure chamber can be directly used for discharging the medium through the discharge opening. For this a direct connection is provided between the pressure chamber and the discharge opening, a discharge valve being preferably provided and only opens when a specific minimum pressure is reached. However it is alternatively also possible for the medium delivered by the pumping device to be initially fed into another chamber from which it is discharged by means of a specific discharge mechanism.

Thus, preferably a discharge chamber connected to the pressure chamber is provided, said discharge chamber being connected to the environment by a plurality of discharge openings and where the discharge chamber is bounded by a wall section, which can be brought into a vibration state by a vibration actuator.

With such a design the actual discharge process is brought about by the vibrating wall section, which leads to a high frequency pulsating volume of the discharge chamber. As a result of this volume change the medium present in the pressure chamber passes out of the discharge opening in the form of a mist with minute droplets. The pressure produced by the pumping device is merely used for supplying the discharge chamber with medium. Particularly with such a design the use of an inventive piezoactuator device or an inventive coil actuator device is advantageous, because said device makes it possible to provide a precisely dosed, limited pressure dimensioned in such a way that the discharge chamber medium supply is ensured without a discharge through the discharge opening taking place merely as a result of the pressure produced by the pumping device.

According to a further development for controlling the pumping device a control unit is provided, which controls a force application to the piston by means of the piezoactuator device or the coil actuator device. In the case of a piezoactuator device control takes place in that the control unit makes available a clearly defined voltage. With a coil actuator device the control unit provides a clearly defined current intensity. The voltage or current intensity directly influence the force applied to the piston. Whilst including the piston surface this makes it possible to produce a clearly defined pressure in the pressure chamber. So that this clearly defined pressure can be obtained independently of other influencing factors such as frictional forces between piston and pump cylinder wall, values determined beforehand by the measuring device can be incorporated, e.g. the time required when the pressure chamber is still empty to transfer the piston from one end position into the other. For this purpose the control unit is preferably additionally constructed in order to detect frictional and/or spring forces acting on the piston through an evaluation of the values determined by the measuring device during a piston displacement.

The control unit can also be constructed for determining by means of a measurement of the piston displacement on putting the discharge device into operation whether air is still enclosed in a flow path between pumping device and discharge opening. The control unit can also be used for numerous other purposes, e.g. for counting the number of discharge processes or preventing a discharge process if a certain time period has not elapsed since a preceding discharge process.

### BRIEF DESCRIPTION OF THE DRAWINGS

Further aspects and features of the invention can be gathered from the claims and the subsequent description of three preferred embodiments of the invention shown in the drawings and described hereinafter. In the drawings show:

FIG. 1 A first embodiment of an inventive discharge device with a coil actuator device and a discharge valve opening in pressure-dependent manner.

FIG. 2 A second embodiment of an inventive discharge device with a coil actuator device and an atomizer.

FIG. 3 A third embodiment of an inventive discharge device with a piezoactuator device and a discharge valve opening in pressure-dependent manner.

### DETAILED DESCRIPTION OF THE EMBODIMENTS

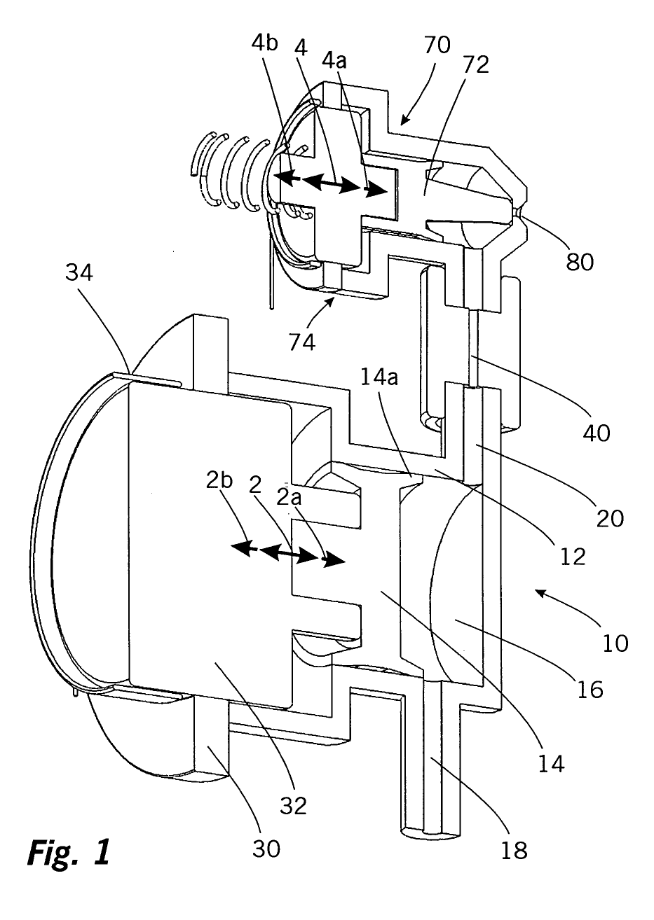

FIG. 1 shows a first embodiment of a inventive discharge device having a pumping device 10 connected by means of a channel 40 to a discharge valve 70. FIG. 1 does not show further discharge device components which largely coincide with the known prior art components. Thus, a casing with a medium reservoir surrounding the discharge device is not shown. The discharge device also has a not shown control unit, which is e.g. operable by means of key switches and which is provided for controlling a discharge process.

Pumping device 10 has a pump cylinder 12, which defines a pressure chamber 16 together with a piston 14. The piston has a circumferential piston lip 14a engaging in liquid-tight manner on the pump cylinder. As a result of the mobility of piston 14 it is possible to vary the volume of pressure chamber 16 and to pressurize liquid in said chamber 16. Into the pressure chamber 16 issue an intake channel 18 and a discharge channel 20 connected by means of connecting channel 40 to discharge valve 70. Intake channel 18 and discharge channel 20 are displaced relative to a movement direction 2 of piston 14, so that during a movement of the piston in direction 2a firstly the intake channel 18 leading to the not shown medium reservoir is separated from the pressure chamber.

On the left-hand side to the piston 14 is connected a coil actuator device, which comprises an actuator coil 30 and an actuator core 32 surrounded by the actuator coil 30. Actuator core 32 is firmly connected by a plug connection to piston 14, so that the actuator core always moves together with piston 14. The actuator core 32 is also surrounded by measuring coil 34, which runs parallel to actuator coil 30.

Pressure generation in pressure chamber 16 takes place in the following way:

The not shown control unit introduces current into actuator coil 30 which generates a magnetic field in the vicinity of actuator core 32. The strength of said magnetic field is dependent on the current intensity in actuator coil 30. As a result of the magnetic field the actuator core 32, which is at least zonally constructed in permanent magnetic manner, is supplied with a force in direction 2a or 2b. Force application in direction 2a also forces piston 14 in direction 2a towards pressure chamber 16. As soon as piston lip 14a of piston 14 has passed over intake channel 18, said force produces a pressure in the volume-reduced pressure chamber 16. Said pressure also acts on the valve body 72 of discharge valve 70, which is consequently moved in direction 4b and consequently frees the discharge opening 80 previously closed by valve body 72. The discharge process is brought about by said opening of discharge opening 80.

The discharge process ends as soon as the force application to piston 14 is terminated. This can be brought about by stopping the energization of actuator coil 30. It is alternatively possible through an additional coil device 7 on discharge valve 70 to again press the valve body 72 back into the closed position of FIG. 1 counter to the fluid pressure and thereby terminate the discharge process.

On ending the discharge process a reverse polarity current is supplied to actuator coil 30, so that force is applied to actuator core 32 and piston 14 in direction 2b. As at this time discharge valve 70 is closed again, the resulting enlargement of the pressure chamber 16 leads to an underpressure, which sucks medium out of the medium reservoir when piston lip 14 has passed over intake channel 18.

As a result of the described control of actuator coil 30 it is possible to apply a largely defined force to piston 14, so that there is a pressure generation with a largely defined pressure. If particularly high demands are made regarding the pressure to be produced in pressure chamber 16 in connection with the maintaining of a desired pressure value, account must also be taken of the fact that frictional forces occur between piston 14 and cylinder wall 12 and during pressurization said forces act counter to the movement direction of piston 14. To determine the level of said frictional forces, prior to the initial filling of pressure chamber 16 a measurement with measuring coil 34 takes place. By a clearly defined current intensity in actuator coil 30, piston 14 is moved from its first end position into its second end position and the measuring coil 34 simultaneously detects how long this process takes. The higher the frictional forces, the longer the movement time interval.

This detected time interval can subsequently be used for compensating the frictional forces by varying the current intensity in actuator coil 30 during the pressurizing of the medium in pressure chamber 16 and for producing the desired pressure ratios in the pressure chamber 16.

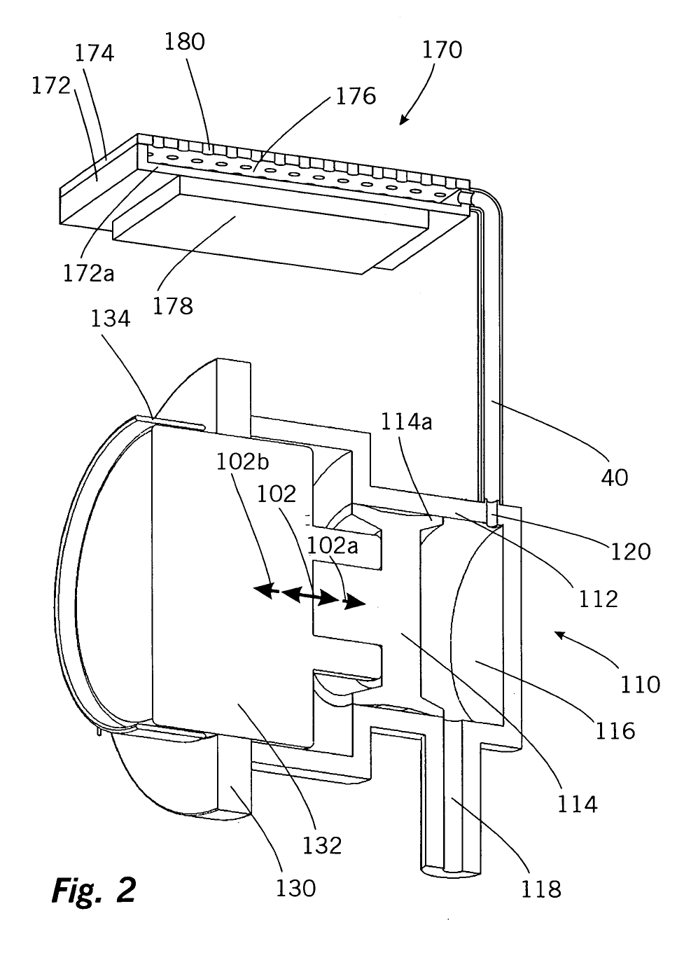

The discharge device according to FIG. 2 largely corresponds to that of FIG. 1. No differences arise with regards to the pumping device 110, so that what has been stated concerning the embodiment of FIG. 1 again applies. Unlike in the embodiment of FIG. 1 there is no discharge valve and it is instead replaced by an atomizer 170 connected by a line 140 to pressure chamber 116. Said atomizer comprises a casing 172 terminated on its top side by a perforated plate 174, said perforated plate 174 and said casing 12 jointly enclosing a discharge chamber 176. On the side of the casing 172 remote from perforated plate 174 a vibration piezo-device 178 is provided on a vibration wall section 172a and as a result of high frequency vibration can bring about a vibration of vibration wall section 172a. These vibrations in vibration wall section 172a lead to a high frequency volume change of discharge chamber 176 through which the medium enclosed in chamber 176 is pressed through the discharge openings 180 of perforated plate 174 and escapes in the form of a mist.

The representation of FIG. 2 is not true to scale. Atomizer 170 has been represented on a significantly larger scale than pumping device 110. Thus, in reality, the volume of pressure chamber 116 is much larger than the volume of discharge chamber 176, so that a long lasting discharge process enables the medium to be fed into the pressure chamber 116.

During operation the discharge device of FIG. 2 is so controlled by the not shown control unit that only a very limited overpressure is produced in pressure chamber 116. This limited overpressure ensures that the discharge chamber 176 permanently remains in a filled state without the pressure produced by pumping device 110 bringing about a discharge of medium through discharge openings 180 independent of the vibration of vibration wall 172a.

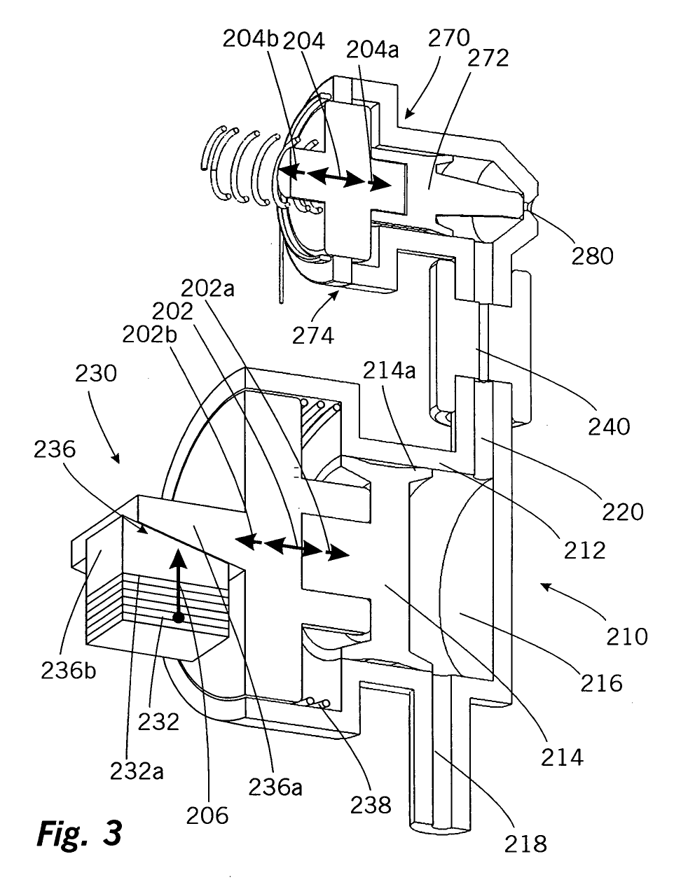

In the embodiment of FIG. 3 the structure of the embodiment of FIG. 1 has been retained, except that a force is not applied by the coil actuator device to piston 214 and instead this takes place through the piezoactuator device 230. Said piezoactuator device 230 comprises a piezo-stack 232 which increases its extension in direction 206 when a voltage is applied. Said direction 206 forms a right angle with the movement direction 202 of piston 214. For transmitting the force from piezo-stack 232 to piston 214 a converter 236 is provided and comprises two wedge elements 236a, 236b. Wedge element 236b is provided on the movable end 232a of piezo-stack 232. The other wedge element 236a is engaged onto the side of piston 214 remote from pressure chamber 216. The wedge surfaces form an angle of approximately 15ø with movement direction 202, so that a displacement of the movable end 232a of piezo-stack 232 leads to a much greater displacement of piston 214. A comparatively small movement of piezo-stack 232 can consequently bring about a much larger piston stroke.

The represented design consequently makes it possible to use the force produced by piezo-stack 232 for pressurization in pressure chamber 216. As converter 236 is so designed that it is only possible to apply a force to piston 214 in direction 202a, a return spring 238 is also provided and when the force produced by the piezo-stack 232 is ended it presses piston 214 back into its starting position.

1. A discharge device for a liquid pharmaceutical medium, said device comprising
a reservoir for storing the medium,
a pressurizing device for feeding the medium,
at least one discharge opening for delivering the medium to an environment,
a pressure chamber whose content is pressurizable by means of a piston movable in translational manner provided in the pressurizing device, and
a piezoactuator device with a piezoactuator operatively coupled to the piston or
a coil actuator device with an actuator coil and an actuator core, to which a force can be applied relative to the actuator coil by energizing the latter and either the actuator coil or actuator core is fixed relative to the piston.

2. The discharge device according to claim 1, wherein the piezoactuator device is operatively coupled by means of a converter to the piston, the converter displacing the piston by a path length L2 as a consequence of a deformation of the piezoactuator by a path length L1, L2 being greater than L1.

3. The discharge device according to claim 1, wherein the actuator coil is fixed relative to a pump casing and the actuator core is fixed relative to the piston or the actuator core is fixed relative to the pump casing and the actuator coil is provided in a fixed manner on the piston.

4. The discharge device according to claim 1, wherein a measuring device is provided for detecting the deflection of the piston relative to a pump casing.

5. The discharge device according to claim 4, wherein the measuring device has a measuring coil constructed for detecting the position of a measuring core relative to a measuring coil.

6. The discharge device according to claim 1, wherein a discharge chamber is connected to the pressure chamber and connected to the environment by a plurality of discharge openings, the discharge chamber being bounded by a wall section which can be brought into a vibration state by a vibration actuator.

7. The discharge device according to claim 4, wherein a control device controls a force application to the piston by means of the piezoactuator device or coil actuator device and the control unit additionally
detect the frictional and/or spring forces acting on the piston by an evaluation of the values determined by the measuring device during a displacement of the piston and/or
put the discharge device into operation based on a measurement of the displacement of the piston.
